(19) United States
(12) Patent Application Publication
(10) Pub. No.: US 2016/0191133 A1
(43) Pub. Date: Jun. 30, 2016

(54) CONTROL DEVICE FOR MULTIPLEXING ANTENNA AND BEAM FORMING DEVICE INCLUDING THE SAME

(71) Applicant: Electronics and Telecommunications Research Institute, Daejeon (KR)

(72) Inventors: Go San NOH, Daejeon (KR); Youn Ok PARK, Daejeon (KR)

(21) Appl. No.: 14/949,394

(22) Filed: Nov. 23, 2015

(30) Foreign Application Priority Data
Dec. 30, 2014 (KR) 10-2014-0193057
Mar. 6, 2015 (KR) 10-2015-0062849

(51) Int. Cl. H04B 7/06

(52) U.S. Cl. CPC H04B 7/0617

(57) ABSTRACT

Provided is a beam forming device forming a beam based on an RF signal, including: a multiplexing control module determining a beam feature of the beam based on user terminal information and generating multiplexing control information on which the beam feature is reflected; an antenna multiplexing module receiving the RF signal and multiplexing the RF signal according to the generated multiplexing control information; and an antenna array including multiple antenna elements to form a beam according to the multiplexed RF signal.

### CROSS-REFERENCE TO RELATED APPLICATIONS

This application claims priority to and the benefit of Korean Patent Application No. 10-2014-0193057 filed in the Korean Intellectual Property Office on Dec. 30, 2014, and Korean Patent Application No. 10-2015-0062849 filed in the Korean Intellectual Property Office on Mar. 6, 2015, the entire contents of which are incorporated herein by reference.

### TECHNICAL FIELD

The present invention relates to a control device for multiplexing an antenna, which is used to control a beam in a hybrid beam forming based wireless communication system and a beam forming device including the same.

### BACKGROUND ART

In wireless communication, various communication schemes have been proposed for improving performance and a resource usage efficiency. The aforementioned conventionally proposed communication schemes use wireless resources such as a time, a frequency, a code, a space, and the like. That is, examples of the conventionally proposed communication schemes are a time division multiple access (TDMA) scheme, a frequency division multiple access (FDMA) scheme, a code division multiple access (CDMA) scheme, and a space division multiple access (SDMA) scheme.

As a newly proposed resource, there is a beam in a multiple antenna system or in a directional antenna system and as a communication scheme using the beam, a beam division multiple access (BDMA) scheme is proposed.

In a multi-antenna based communication system, a degree-of-freedom in a spatial domain can be acquired. By using the degree-of-freedom, an error rate can be reduced through spatial diversity and frequency using efficiency may be increased through spatial multiplexing.

Meanwhile, since a millimeter wave which is a frequency between several tens of GHz to several hundreds of GHz has a feature in which a wavelength is very short, an interval between antennas can be maintained to be very small, and as a result, a lot of antennas can be deployed in a small area. Therefore, pencil beam-forming in which a beam width is very small and directivity is strong becomes possible and beam-division multiple accesses that distinguish multiple users to be accessible with the beam become possible. By the beam-division multiple access, a beam having a small beam width is allocated to each of user terminals which are spatially distributed to minimize interuser interference and enable multiple access.

The BDMA scheme can be implemented through hybrid beam-forming in which analog beam-forming and digital beam-forming are coupled and beam-forming and multiple stream transmission are implementable with low complexity. That is, multiple beams are generated through the analog beam-forming and multiple accesses for the generated beams are realized through the digital beam-forming.

### SUMMARY OF THE INVENTION

General BDMA technology has a limit that a path from an RF path passing through digital beam-forming to individual antenna connection units for analog beam-forming is fixed, and as a result, a desired beam width, a desired beam gain, and the desired number of beams cannot be adaptively generated.

The present invention is contrived by considering the aforementioned matter and the present invention has been made in an effort to provide a control device for multiplexing an antenna, which can flexibly and actively control beam features such as a beam width, a beam gain, the number of beams, and the like based on user terminal information and a beam forming device. The beam features can be adjusted to fit the characteristics of each user terminal. For example, the control device may form a broad beam for a user with high mobility in order to avoid unnecessarily frequent hand-offs. Oppositely, the control device may form a narrow beam for a user with a low mobility in order to reduce the interference between users.

Other technical problems and solving means of the present invention can be appreciated by the following description and will be more apparent by the exemplary embodiments of the present invention. Further, the technical problems and the solving means of the present invention can be implemented by means and combinations thereof described in claims.

An exemplary embodiment of the present invention provides a beam forming device forming a beam based on an RF signal, including: a multiplexing control module determining a beam feature of the beam based on user terminal information and generating multiplexing control information on which the beam feature is reflected; an antenna multiplexing module receiving the RF signal and multiplexing the RF signal according to the generated multiplexing control information; and an antenna array including multiple antenna elements to form a beam according to the multiplexed RF signal.

The device may further include an analog beam forming module applying phase shift and power amplification to the multiplexed RF signal to generate an analog beam forming signal. In this case, the antenna array may form the beam according to the analog beam forming signal.

The beam feature may include the number of beams, a direction of the beam, a beam width of the beam, or a beam gain of the beam.

The user terminal information may include the number of user terminals, and the multiplexing control module may determine the number of beams based on the number of user terminals.

The user terminal information may include the position of the user terminal, and the multiplexing control module may determine the direction of the beam based on the position of the user terminal.

The user terminal information may include a velocity of the user terminal, and the multiplexing control module may determine the beam width of the beam based on the velocity of the user terminal.

The multiplexing control module may determine mapping indexes of antenna elements to form the beam by using the determined beam width. In this case, a table including the mapping indexes may be included in the multiplexing control information.

The mapping indexes of the antenna elements to form the beam may be different from each other for each beam.

According to another exemplary embodiment of the present, the multiplexing control module as an independent device module is included in a beam forming device to be connected to an antenna multiplexer incorporated in the beam forming device.

As such, as the independent device module, the multiplexing control module may include: a receiving unit receiving user terminal information; a multiplexing control information generating unit determining a beam feature of a beam to be formed by the beam forming device based on the user terminal information and generating multiplexing control information on which the beam feature is reflected; and a transmitting unit transmitting the multiplexing control information to an antenna multiplexer incorporated in the beam forming device.

According to various exemplary embodiments of the present invention, since multiplexing between an RF path and an antenna input unit becomes possible, beam features such as a beam width, a beam gain, the number of beams, and the like can be actively controlled.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 illustrates a hybrid beam-forming device according to an exemplary embodiment of the present invention.

FIG. 2 illustrates a beam forming device according to an exemplary embodiment of the present invention.

FIG. 3 illustrates a block diagram of a multiplexing control device according to an exemplary embodiment of the present invention.

FIG. 4 illustrates a flowchart of a method for multiplexing an RF-antenna according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The present invention may be variously modified and have several exemplary embodiments. Therefore, specific exemplary embodiments of the present invention will be illustrated in the accompanying drawings and be described in detail in the detailed description. However, this is not intended to limit the present invention to the specific exemplary embodiments, and it should be understood that the present invention covers all the modifications, equivalents and replacements included in the spirit and technical scope of the present invention. In describing the present invention, when it is determined that the detailed description of the publicly known art related to the present invention may obscure the gist of the present invention, the detailed description thereof will be omitted.

Terms used in the present application are used only to describe specific exemplary embodiments, and are not intended to limit the present invention. Singular expressions used herein include plurals expressions unless they have definitely opposite meanings in the context. In the present application, it should be understood that the term “include” or “have indicates that a feature, a number, a component, a part or the combination thereof described in the specification is present, but does not exclude a possibility of presence or addition of one or more other features, numbers, components, parts or combinations thereof, in advance.

Hereinafter, exemplary embodiments of the present invention will be described in detail with reference to the accompanying drawings.

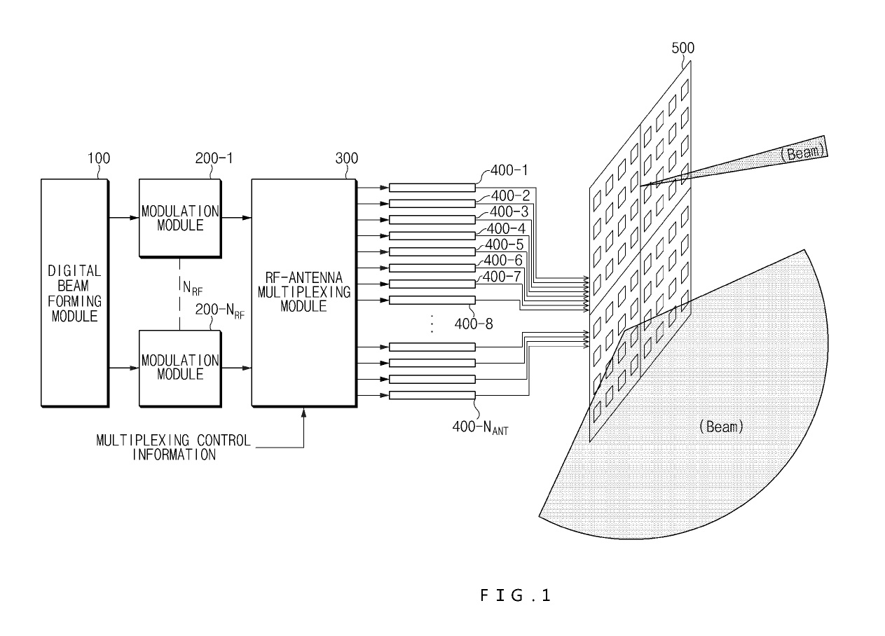

FIG. 1 illustrates a hybrid beam-forming device according to an exemplary embodiment of the present invention.

Referring to FIG. 1, a hybrid beam forming device forming a beam based on an RF signal may include a digital beam forming module 100, N_{RF} modulation modules (modulators) 200-1 to 200-N_{RF}, an RF-antenna multiplexing module 300, N_{ANT} analog beam forming modules 400-1 to 400-N_{ANT}, and an antenna array 500.

The digital beam forming module 100 may generate signals to which precoding is applied with respect to individual RF paths. In this case, the maximum number of generatable RF paths is represented by N_{RF}. During a digital beam forming process by the digital beam forming module 100, N_{RF} RF paths or less may be generated. According to the exemplary embodiment, the number of RF paths may mean the maximum number of simultaneous access users which are beam based multiple accessible.

The modulation modules 200-1 to 200-N_{RF} may be provided as many as the number (N_{RF}) corresponding to the maximum RF paths. The modulation modules 200-1 to 200-N_{RF} may modulate signals generated by the digital beam forming module 100 for each of the RF paths. In this case, a scheme of modulation by each of the modulation modules 200-1 to 200-N_{RF} may include, for example, an orthogonal frequency division multiplexing (OFDM) scheme or a filter bank multi-carrier (FBMC) scheme.

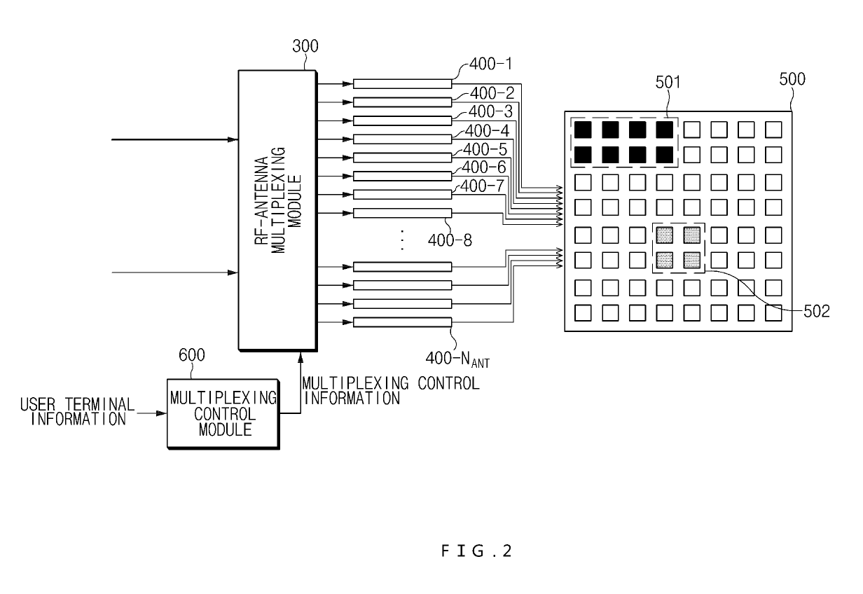

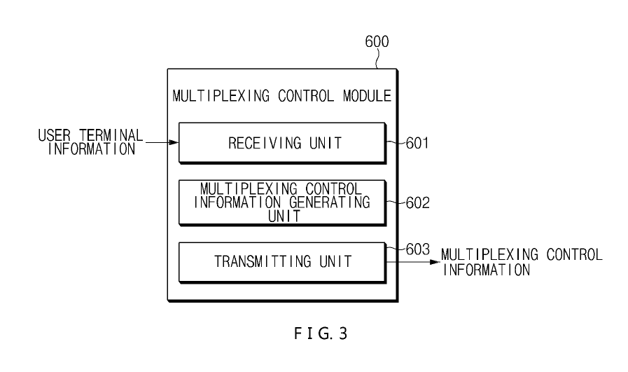

The RF-antenna multiplexing module 300 may multiplex the RF signal received for each RF path according to multiplexing control information. That is, the RF-antenna multiplexing module 300 may generate RF signals multiplexed for each RF path based on multiple RF signals modulated in the modulation modules 200-1 to 200-N_{RF} and multiplexing control information received from a multiplexing control device (alternatively, multiplexing control module). The multiplexing control information will be described in detail with reference to FIGS. 2 and 3. Meanwhile, the RF signals multiplexed for each RF path by the RF-antenna multiplexing module 300 may be input in the analog beam forming modules 400-1 to 400-N_{ANT} (that is, an input unit of an RF-antenna).

The analog beam forming modules 400-1 to 400-N_{ANT} may be provided at an input unit side of the antenna array 500 and provided with N_{ANT} (however, N_{RF}<N_{ANT}). The analog beam forming modules 400-1 to 400-N_{ANT} apply phase shift and amplification to the multiplexed RF signal to generate an analog beam forming signal. That is, the analog beam forming modules 400-1 to 400-N_{ANT} may apply a power amplification gain value and a phase shift value appropriate to beam forming to the signal received from the RF-antenna multiplexing module 300. The generated analog beam forming signal may be transferred to the antenna array 500.

The antenna array 500 may include an array of multiple antenna elements and form a beam according to the multiplexed RF signal (e.g., analog beam forming signal). For example, a total of N_{RF} beams may be formed and transmitted through N_{ANT} antenna elements. The analog beam forming signal generated by the analog beam forming modules 400-1 to 400-N_{ANT} is provided to the antenna array 500 including the multiple antenna elements to form a desired beam.

FIG. 2 illustrates a beam forming device according to an exemplary embodiment of the present invention.

Referring to FIG. 2, the beam forming device according to the exemplary embodiment of the present invention may include some components (e.g., the RF-antenna multiplexing module 300, the analog beam forming modules 400-1 to 400-N_{ANT}, and the antenna array 500) of the hybrid beam forming device and a multiplexing control module 600 illustrated in FIG. 1. A description duplicated in relation with FIG. 1 may be omitted.

The multiplexing control module 600 may receive user terminal information from the outside, determine a beam feature of the beam based on the user terminal information, and generate multiplexing control information on which the determine beam feature is reflected. The multiplexing control information may be provided to the RF-antenna multiplexer 300 and the RF-antenna multiplexer 300 may multiplex the signal received through the RF path to an antenna element mapped according to the multiplexing control information. The multiplexed signal may include the same signal as a common RF path signal.

The user terminal information received by the multiplexing control module 600 may include, for example, the number of user terminals, the position of the user terminal, and a velocity of the user terminal. The beam features may include the number of beams, a direction of the beam, a beam width, or a beam gain.

According to the exemplary embodiment, the multiplexing control module 600 may determine the number of beams based on the number of user terminals. For example, when one beam is formed for each user terminal, the multiplexing control module 600 may generate the number of beams formed by the beam forming device as many as the user terminals. According to any exemplary embodiment, the number of beams may be smaller than the number of user terminals.

According to the exemplary embodiment, the multiplexing control module 600 may determine the direction of the beam based on the position of the user terminal. The multiplexing control module 600 may determine the beam transmitted from the antenna array 500 of the beam forming apparatus to be formed in a direction in which the user terminal is positioned.

According to the exemplary embodiment, the multiplexing control module 600 may determine the beam width of a beam to be formed based on a movement velocity of the user terminal For example, the multiplexing control module 600 may determine the beam width to be small when the user terminal stops at a specific position or less moves. On the contrary, when the multiplexing control module 600 has mobility in a horizontal direction in a vertical direction based on a direction in which the user terminal observes in the antenna array 500, the beam width may be determined to be large in the horizontal direction or the vertical direction.

Since a movement velocity (including the movement direction) of the user terminal is determined in a 3D space, when the user terminal is viewed from the antenna array 500, the movement velocity (with respect to the ground) of the user terminal may be divided into a horizontal velocity component v_{H} and a vertical velocity component v_{V}. In this case, when a minimum value of a horizontal beam width formable in the antenna array 500 is θ_{H}^{min}, a maximum value of the formable horizontal beam width is θ_{H}^{max}, a minimum value of a formable vertical beam width is θᵥ^{min}, and a maximum value of the formable vertical beam width is θᵥ^{max}, the horizontal component beam width θ_{H} and the vertical component beam width θᵥ of the beam formed by the antenna array 500 may be determined by [Equation 1] and [Equation 2], respectively.

$$\begin{matrix}{θ}_{H} = \{ \begin{matrix}{θ}_{H}^{min} , when {av}_{H} < {θ}_{H}^{min} \\ α {v}_{H} , when {θ}_{H}^{min} \leq {av}_{H} \leq \\ {θ}_{H}^{max} , when {θ}_{H}^{max} \leq {av}_{H}\end{matrix} {θ}_{H}^{max} & [ Equation 1 ] \\ {θ}_{V} = \{ \begin{matrix}{θ}_{V}^{min} , when {bv}_{V} < {θ}_{V}^{min} \\ {bv}_{V} , when {θ}_{V}^{min} \leq {bv}_{V} \leq \\ {θ}_{V}^{max} , when {θ}_{V}^{max} \leq {bv}_{V}\end{matrix} {θ}_{V}^{max} & [ Equation 2 ]\end{matrix}$$

a and b as constants having a unit of degree·sec/meter may be inductively determined by a deployment structure and the beam feature of the antenna element of the antenna array 500.

Meanwhile, when the beam width is determined, a gain (beam-forming gain) of the beam may be determined depending on a value of the beam width which is in inverse proportion thereto. As the number of antenna elements forming the beam (that is, as the number of antennas of which power is turned on increases) increases, the beam width may decrease and the beam-forming gain may increase. On the contrary, as the number of antenna elements forming the beam (that is, as the number of antennas of which power is turned off decreases) decreases, the beam width may increase and the beam-forming gain may decrease. When such a principle is extended to 2D, the desired beam width and beam-forming gain in the horizontal direction and the vertical direction may be applied to each beam.

According to the exemplary embodiment, when the beam width (that is, the horizontal component beam width θ_{H} and the vertical component beam width θᵥ) is determined, the multiplexing control module 600 may determine a mapping index for specifying an antenna element to form the beam by using the determined beam width. A table including the mapping index may be included in the multiplexing control information provided to the RF-antenna multiplexer 300. The mapping index of the antenna element may be based on the number of antenna elements that form the beam.

For example, when the antenna array 500 is a uniform array based on a half power beam width (HPBW), the number of horizontal antenna elements, N_{H} and the number of vertical antenna elements, N_{V} may be determined by [Equation 3] given below.

$${N}_{H} = \frac{c}{{θ}_{H}} , {N}_{V} = \frac{d}{{θ}_{V}} \qquad [ Equation 3 ]$$

The c and d as constants influenced by an antenna shape (the array of the antenna elements) may each have a value of approximately 102° when an interval between the antenna elements is a half wavelength.

As found in [Equation 3], the number of antenna elements that form the beam may be in inverse proportion to the beam width. That is, as the number of antenna elements used for forming the beam increases, beam patterns by the respective antenna elements are spatially synthesized to form a sharp beam width. However, in order to form a beam having a desired beam width more accurately, an antenna structure, an antenna array shape, an inter-antenna interval, and the like may be additionally considered.

When the number of horizontal antenna elements, N_{H} and the number of vertical antenna elements, N_{V} are determined through [Equation 3], the mapping index table of the antenna element according to each RF path may be specified in a quadrangular shape as many as N_{H}×N_{V} for each beam.

For example, when the number of horizontal antenna elements, N_{H} and the number of vertical antenna elements, N_{V} are determined, the multiple antenna elements provided in the antenna array 500 may be sequentially selected from an upper-left end. When it is assumed that a configuration of the mapping index for a 0-th RF path is a 2D antenna array, the corresponding antenna array may include (X0_{UL}, Y0_{UL}) corresponding to an upper-left antenna element and (X0_{LR}, Y0_{LR}) corresponding to a lower-right antenna element.

For example, when each antenna element included in the antenna array 500 of FIG. 2 is regarded as a matrix component, a mapping index table of antenna elements 501 forming a specific beam may be specified in a rectangular shape as many as 2×4. The mapping index table of the antenna elements 501 may include (1, 1) corresponding to the upper-left antenna element and (2, 4) corresponding to a lower-right antenna component.

In this case, in the mapping index, the antenna elements specified for each beam may not overlap with each other between different beams. That is, the multiplexing control module 600 may specify the mapping index of the antenna element to form the beam differently for each beam. Therefore, multiple beams may be prevented from being allocated to one antenna element. For example, referring to FIG. 2, antenna elements 501 and antenna elements 502 forming different beams may not overlap with each other.

FIG. 3 illustrates a block diagram of a multiplexing control device according to an exemplary embodiment of the present invention.

Referring to FIG. 3, the multiplexing control device 600 according to the exemplary embodiment of the present invention may include a receiving unit 601, a multiplexing control information generating unit 602, and a transmitting unit 603. For example, the multiplexing control device 600 may be included in a base station device and connected to a beam forming device having the antenna multiplexer therein. In other words, the multiplexing control module 600 of FIG. 1 as a stand-alone device module may be included in the base station device.

The receiving unit 601 may, for example, receive user terminal information from a base station. For example, the user terminal information may include the number of user terminals, the number of streams to be allocated to each user terminal, the position, a movement direction, or a movement velocity of the user terminal, and the like.

The multiplexing control information generating unit 602 may determine a beam feature of a beam to be formed by the beam forming device based on the user terminal information and generate multiplexing control information on which the beam feature is reflected.

According to the exemplary embodiment, the multiplexing control information generating unit 602 may determine a feature of a beam to be formed by each antenna element of the antenna array 500 of FIG. 2. The feature of the beam may include at least one of the number of beams, a direction of the beam, a beam width, and a beam-forming gain.

According to one example, the multiplexing control information generating unit 602 may determine the number of beams based on the number of user terminals or the number of streams to be allocated to each user terminal. Further, the multiplexing control information generating unit 602 may determine the direction of the beam based on the position of the user terminal. Moreover, the multiplexing control information generating unit 602 may determine the beam width based on the velocity of the user terminal.

According to the exemplary embodiment, the multiplexing control information generating unit 602 may decide the mapping index of the antenna element to form the beam by using the determined beam width and a table including the mapping index may be included in the multiplexing control information transmitted to the antenna multiplexer (e.g., the RF-antenna multiplexing module 300 of FIG. 2) of the beam forming device.

For example, the multiplexing control information generating unit 602 may determine the number (horizontal number and vertical number) of antenna elements mapped according to the determined beam width and specify mapping indexes of antenna elements for all formed beams based on the number of antenna elements. The mapping index of the antenna element may not overlap between different beams. That is, the mapping index may vary for each formed beam.

The transmitting unit 603 may transmit the multiplexing control information to the antenna multiplexer incorporated in the beam forming device. A phase of the signal multiplexed by the antenna multiplexer may be shifted by an analog beam former and power of the signal may be amplified and thereafter, the signal may be transmitted to the mapped antenna element.

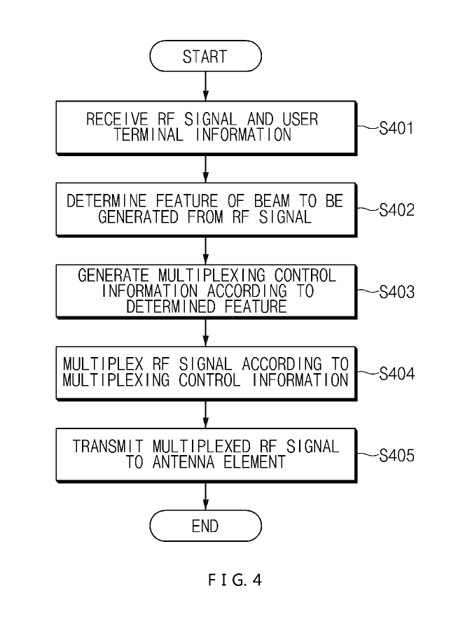

FIG. 4 illustrates a flowchart of a method for multiplexing an RF-antenna according to an exemplary embodiment of the present invention.

Referring to FIG. 4, an antenna multiplexing method by an antenna multiplexing device or an antenna multiplexing module may include operations S401 to S405.

In operation S401, an antenna multiplexer 300 may receive an RF signal and user terminal information. In operation S402, the antenna multiplexer 300 may determine a feature of a beam to be generated from the RF signal by using the received user terminal information. In operation S403, the antenna multiplexer 300 may generate multiplexing control information according to the feature determined in operation S402. The multiplexing control information may include information on the feature of the beam and/or a mapping index table for an antenna element to form the beam. In operation S404, the antenna multiplexer 300 may multiplex the RF signal according to the multiplexing control information generated in operation S403. In operation S405, the antenna multiplexer 300 may transmit the multiplexed RF signal to the antenna element. The multiplexed signal may be phase-shifted and power-amplified by the analog beam former.

According to various exemplary embodiments of the present invention, since multiplexing between an RF path and an antenna input unit becomes possible, beam features such as a beam width, a beam gain, the number of beams, and the like can be actively controlled. The beam features can be adjusted to fit the characteristics of each user terminal. For example, the control device may form a broad beam for a user with high mobility in order to avoid unnecessarily frequent hand-offs. Oppositely, the control device may form a narrow beam for a user with a low mobility in order to reduce the interference between users.

The RF-antenna multiplexing method according to FIG. 4 may be prepared even by a computer program. In addition, codes and code segments constituting the program can be easily deduced by a computer programmer skilled in the art. Further, the prepared program is stored in a computer readable recording medium (information storage medium) and is read and executed by a computer to implement the method of the present invention. In addition, the recording medium includes all types of computer readable recording media.

Descriptions in the present specification as exemplary embodiments do not limit the scope of the present invention by any method. For simplification of the specification, circuit components, control systems, software, and other functional aspects of the systems in the related art may not be described. Further, connections of lines or connection members among components illustrated in the drawings exemplarily show functional connections and/or physical or circuit connections and may be expressed as replaceable or additional various function connections, physical connection, or circuit connections in actual devices. In addition, if not mentioned in detail like “requisitely”, “importantly”, and the like, the corresponding component may not be a component particularly required for applying the present invention.

In the specification (particularly, the claims) of the present invention, a term of “the’ and indication terms similar thereto may be used in both the singular number and the plural number. Further, when “range” is disclosed in the present invention, the range includes the present invention in which individual values included in the range are applied(if there is no disclosure contrary thereto) and it is the same as the respective individual values constituting the range being disclosed in the detailed description of the present invention. All examples or exemplary terms (e.g., etc.) in the present invention are just used for, in detail, describing the present invention and if the examples or exemplary terms are not limited by the claims, the range of the present invention is not limited by the examples or exemplary terms. Further, it can be appreciated by those skilled in the art that various modifications, combinations, and changes may be configured according to a design condition and a design factor within a scope of the appended claims or the equivalent thereto.

The present invention described as above is not limited by the aforementioned exemplary embodiments and the accompanying drawings because it will be apparent to those skilled in the art that various substitutions, modifications, and changes can be made within the scope without departing from the technical spirit of the present invention.

What is claimed is:

1. A beam forming device forming a beam based on an RF signal, the device comprising:
a multiplexing control module determining a beam feature of the beam based on user terminal information and generating multiplexing control information on which the beam feature is reflected;
an antenna multiplexing module receiving the RF signal and multiplexing the RF signal according to the generated multiplexing control information; and
an antenna array including multiple antenna elements to form a beam according to the multiplexed RF signal.

2. The device of claim 1, further comprising:
an analog beam forming module applying phase shift and power amplification to the multiplexed RF signal to generate an analog beam forming signal,
wherein the antenna array forms the beam according to the analog beam forming signal.

3. The device of claim 1, wherein the beam feature includes the number of beams, a direction of the beam, a beam width of the beam, or a beam gain of the beam.

4. The device of claim 3, wherein the user terminal information includes the number of user terminals, and
the multiplexing control module determines the number of beams based on the number of user terminals.

5. The device of claim 3, wherein the user terminal information includes the position of the user terminal, and
the multiplexing control module determines the direction of the beam based on the position of the user terminal.

6. The device of claim 3, wherein the user terminal information includes a velocity of the user terminal, and
the multiplexing control module determines the beam width of the beam based on the velocity of the user terminal.

7. The device of claim 6, wherein the multiplexing control module determines mapping indexes of antenna elements to form the beam by using the determined beam width, and
a table including the mapping indexes is included in the multiplexing control information.

8. The device of claim 7, wherein the mapping indexes of the antenna elements to form the beam are different from each other for each beam.

9. A multiplexing controlling device connected to a beam forming device, the device comprising:
a receiving unit receiving user terminal information;
a multiplexing control information generating unit determining a beam feature of a beam to be formed by the beam forming device based on the user terminal information and generating multiplexing control information on which the beam feature is reflected; and
a transmitting unit transmitting the multiplexing control information to an antenna multiplexer incorporated in the beam forming device.

10. The device of claim 9, wherein the beam feature includes the number of beams, a direction of the beam, a beam width of the beam, or a beam gain of the beam.

11. The device of claim 10, wherein the user terminal information includes the number of user terminals, and
the multiplexing control information generating unit determines the number of beams based on the number of user terminals.

12. The device of claim 10, wherein the user terminal information includes the position of the user terminal, and
the multiplexing control information generating unit determines the direction of the beam based on the position of the user terminal.

13. The device of claim 10, wherein the user terminal information includes a velocity of the user terminal, and
the multiplexing control information generating unit determines the beam width of the beam based on the velocity of the user terminal.

14. The device of claim 13, wherein the multiplexing control information generating unit determines mapping indexes of antenna elements to form the beam by using the determined beam width, and
a table including the mapping indexes is included in the multiplexing control information.

15. The device of claim 14, wherein the mapping indexes of the antenna elements to form the beam are different from each other for each beam.
